(19) United States
(12) Patent Application Publication
(10) Pub. No.: US 2018/0172832 A1
(43) Pub. Date: Jun. 21, 2018

(54) LIDAR SENSOR FOR DETECTING AN OBJECT

(71) Applicant: Robert Bosch GmbH, Stuttgart (DE)

(72) Inventors: Annemarie Holleczek, Braga (PT); Jan Sparbert, Rutesheim (DE)

(21) Appl. No.: 15/848,679

(22) Filed: Dec. 20, 2017

(30) Foreign Application Priority Data
Dec. 21, 2016 (DE) 102016225804.4

(51) Int. Cl. G01S 17/58; F16C 32/04; G01S 7/491; G01S 17/93; G01S 17/02; G02B 27/09

(52) U.S. Cl. CPC G01S 17/58; F16C 32/0406; G02B 27/0955; G01S 17/936; G01S 17/026; G01S 7/4918

(57) ABSTRACT

A LIDAR sensor for detecting an object within a sampling space includes a detector element facing away from the sampling space; a sampling unit that includes a magnetic channel, a guide element, and a movable component situated within the magnetic channel and moved along the guide element under a control using a linear drive; and a refractive element that is situated on the movable component and that faces the sampling space.

### CROSS-REFERENCE TO RELATED APPLICATIONS

The present application claims priority under 35 U.S.C. § 119 to DE 10 2016 225 804.4, filed in the Federal Republic of Germany on Dec. 21, 2016, the content of which is hereby incorporated by reference herein in its entirety.

### FIELD OF THE INVENTION

The present invention relates to a LIDAR sensor, and a method for controlling a LIDAR sensor for detecting an object within a sampling space.

### BACKGROUND

Sensor devices are known from the related art which allow detection of objects within a sampling space in the surroundings, for example of a vehicle. These include light detection and ranging (LIDAR) sensors, for example. Light is emitted from a light source, and the light that is reflected on or scattered at an object in the sampling space is subsequently received by a receiving unit.

A device for deflecting optical beams, preferably for deflecting laser beams, that includes mirror surfaces situated on a drivable solid of revolution is known from DE 4403297. The solid of revolution is made of a monocrystalline material. The mirror surfaces are formed by the crystal planes and have a rotationally symmetrical arrangement.

### SUMMARY

The present invention is directed to a LIDAR sensor for detecting an object within a sampling space, including at least one sampling unit, at least one refractive element, and at least one detector element for receiving light that has been reflected from the object within the sampling space.

According to example embodiments of the present invention, the sampling unit includes at least one movable component, at least one magnetic channel, and at least one guide element. The movable component is situated within the magnetic channel and is movable along the guide element. The movement of the movable component is controllable with the aid of a linear drive. The refractive element is situated on the movable component. The refractive element and the detector element are positioned with respect to one another in such a way that the refractive element is situated closer to the sampling space than is the detector element.

The refractive element can be an optical lens. The refractive element can act as a reception aperture. The refractive element can act as a transmission aperture.

To receive light from a three-dimensional sampling space, in an example embodiment of the present invention, the detector element can be designed as a detector gap. The detector element can be designed as a detector array.

A linear drive is a drive system with the aid of which the movable component can be driven to move. In an example embodiment, the linear drive can be implemented as a linear motor. The guide element includes magnets for this purpose. A magnetic field of the guide element can form. The movable component also includes magnets, and a magnetic field of the movable component can form. A magnet of the guide element can be implemented as an electromagnet. A magnet of the movable component can be implemented as an electromagnet. The movement of the movable component can be achieved by supplying the electromagnets with current having the appropriate polarity. The magnetic fields of the guide element and of the movable component can always be combined in such a way that the movable component is pulled for a distance along a movement direction. The magnetic fields of the guide element and of the movable component can always be combined in such a way that, at any point in time when the linear drive is used for moving the magnetic component, the movable components are repelled by the magnetic field behind them, and at the same time are attracted by the magnetic field situated in front in the direction of motion. When the movable component has reached a new position, this means that the attracting magnetic field is still exerting only a small force on the movable component, and the polarity of the electromagnets can thus be reversed. The movable component can be repelled from the instantaneous position and attracted by the next position. A continuous motion of the mechanical component is thus ensured.

An advantage of the present invention is that a mechanically robust sampling unit can be implemented. The linear drive is largely free of wear, and has a high fatigue strength. Various types of movement can be achieved. The movement of the movable component can be carried out, for example, as translation, as circular translation, or as rotation. The trajectory of the linear drive can be freely designed. Simple optical paths can be achieved. The LIDAR sensor can have an advantageous design, in particular for applications in motor vehicles. The installation volume of the LIDAR sensor can be reduced. In addition, the refractive element can be positioned very precisely in the magnetic channel by the movement of the movable component. The refractive element can receive light from virtually any spatial angle of the sampling space, and can focus light onto the detector element virtually free of loss. As a result, small detector surfaces can be sufficient. Due to the predefined arrangement of the refractive element and of the detector element with respect to the sampling space, the likelihood of detecting interfering radiation that does not pass through the refractive element is reduced with the aid of the detector element.

In an example embodiment of the present invention, the guide element is designed as a magnetic bearing. A magnetic bearing has magnetic forces that can allow a bearing and/or movement without material contact. The magnetic bearing can allow a movement of the movable element without material contact with the guide element.

An advantage of this embodiment is that the magnetic bearing is largely free of wear. It is necessary only to move an essentially small mass. A small electrical power requirement can be sufficient to move the movable element. The magnetic bearing can be designed to be small enough to allow a small installation volume of the LIDAR sensor.

In an example embodiment of the present invention, the sampling unit also includes at least one permanent magnet. A permanent magnet can be part of the magnetic bearing. A magnet of the guide element can be implemented as a permanent magnet. A magnet of the movable component can be implemented as a permanent magnet. An advantage of this embodiment is that magnetic fields can be easily achieved with good reproducibility.

The magnetic channel can be formed by the magnetic fields of the magnets present in the sampling unit. The magnetic channel can include electromagnets and/or permanent magnets.

In another example embodiment of the present invention, the movable component is movable along the guide element with oscillation. An advantage of this embodiment is that the sampling space can be easily sampled with very good reproducibility.

In an example embodiment of the present invention, the movable component is movable along the guide element with resonant oscillation. The movable component can be controlled in such a way that the movable component resonates more intensely. The movable component can behave as a damped harmonic oscillator. An advantage of this embodiment is that a small electrical power requirement may be sufficient to move the movable element.

In another example embodiment of the present invention, the guide element includes magnetic springs at its outer boundaries. The magnetic springs can be implemented as permanent magnets. The magnetic springs can be implemented as electromagnets. An advantage of this embodiment is that the movable component can be prevented from striking against the outer boundaries of the guide element or of the magnetic channel. In addition, the magnetic springs can be used for achieving the resonant oscillation of the movable component. The magnetic springs can act as a repelling force for the damped harmonic oscillation.

In another example embodiment of the present invention, the sampling unit has a semicircular shape. In particular the magnetic channel and the guide element have a semicircular shape. The movable component can thus move on a semicircular path. An advantage of this embodiment is that a large visual field of the LIDAR sensor can be achieved. The visual field can encompass an angular range of up to 120°, for example. Distortions during a measurement can be compensated for by the semicircular path.

In another example embodiment of the present invention, the refractive element is formed from at least one optical lens. The refractive element can be formed from exactly one optical lens, for example. The refractive element can be formed from two optical lenses, for example. The refractive element can be formed from three optical lenses, for example. The refractive element can be formed from four optical lenses, for example. An advantage of this embodiment is that large transmitting and/or receiving devices may be implemented. A simpler approach such as a single lens can be sufficient. More complex optical systems, for example two-lens, three-lens, or four-lens systems, can likewise be used.

In another example embodiment of the present invention, the LIDAR sensor also includes a light source for emitting light into the sampling space. The light source is preferably designed as a laser. The light source can be designed as a combination of multiple lasers. The light source can be part of the sampling unit. In this case, the light source can be positioned on the movable component. An advantage of this embodiment is that light can be emitted into virtually any spatial angle of the sampling space. Alternatively, the light source can be positioned at a predefined distance from the sampling unit.

To emit light into a three-dimensional sampling space, the light source can be expanded in one dimension. Alternatively, the light source can also be designed as a laser array.

In an example embodiment of the present invention, the movable component includes at least one reflective optical element. The light emitted from the light source is deflected into the sampling space with the aid of the reflective optical element. The reflective optical element can be designed as a mirror. The mirror can be planar, or can be curved. The reflective optical element can have a preferably large surface area. An advantage of this embodiment is that the reflective optical element can be positioned very precisely in the magnetic channel by the movement of the movable component. The optical element can emit light into virtually any spatial angle of the sampling space. Light can be emitted at a high transmission power. A preferably small exit window may be implemented. This can be advantageous for the necessary eye safety of the LIDAR sensor. In addition, preferably small cleaning areas result.

In another example embodiment of the present invention, the LIDAR sensor also includes an optical filter. The optical filter is situated on a side of the sampling unit facing the sampling space. The optical filter can be positioned at a predefined distance from the sampling unit. Alternatively, the sampling unit can include the optical filter. The magnetic channel can, for example, include the optical filter as a coating on its outer side. An advantage of this embodiment is that the light strikes the sampling unit at small optical angles, in particular for a semicircular magnetic channel. A narrowband optical filter can thus be used. The signal-to-noise ratio can be increased.

In a method according to example embodiments of the present invention for controlling a LIDAR sensor for detecting an object within a sampling space, the LIDAR sensor includes at least one sampling unit. The method includes a step for controlling the movement of a movable component of the sampling unit within a magnetic channel and along a guide element, with the aid of a linear drive.

In an example embodiment of the method, the guide element is designed as a magnetic bearing. It is provided that the magnetic bearing is controlled with the aid of a bearing controller.

In an example embodiment of the method, it is provided that a position of the movable component on the guide element is determined with the aid of the bearing controller.

Exemplary embodiments of the present invention are explained in greater detail below with reference to the appended drawings.

### BRIEF DESCRIPTION OF THE DRAWINGS

FIG. 1A shows a cross section of a sampling unit with a guide element, a movable component, and magnets of a magnetic bearing, according to an example embodiment of the present invention.

FIG. 1B shows a cross section of a sampling unit with a guide element, a movable component, and magnets of a magnetic bearing, according to another example embodiment of the present invention.

FIG. 2 shows a cross section of a sampling unit with a guide element, a movable component, and magnets of a linear drive, according to another example embodiment of the present invention.

FIG. 3 shows a schematic illustration of a guide element of a sampling unit according to FIG. 2, including the magnets of the linear drive, according to an example embodiment of the present invention.

FIG. 4 shows a cross section of a sampling unit with a guide element, a movable component, and magnets of a linear drive, according to another example embodiment of the present invention.

FIG. 5 shows a schematic illustration of a guide element of a sampling unit according to FIG. 4, including the magnets of a linear drive, according to an example embodiment of the present invention.

FIG. 6A shows a LIDAR sensor with a sampling unit according to an example embodiment of the present invention.

FIG. 6B shows a LIDAR sensor with a sampling unit according to another example embodiment of the present invention

FIG. 6C shows a LIDAR sensor with a sampling unit according to another example embodiment of the present invention

FIG. 6D shows a LIDAR sensor with a sampling unit according to another example embodiment of the present invention.

FIG. 7A shows a cross section of a sampling unit with a refractive element formed from two optical lenses, according to an example embodiment of the present invention.

FIG. 7B shows a cross section of a sampling unit with a refractive element formed from three optical lenses, according to another example embodiment of the present invention.

FIG. 7C shows a cross section of a sampling unit with a refractive element formed from four optical lenses, according to another example embodiment of the present invention.

FIG. 8 shows a top view onto the front surface of a sampling unit of a LIDAR sensor, according to an example embodiment of the present invention.

### DETAILED DESCRIPTION

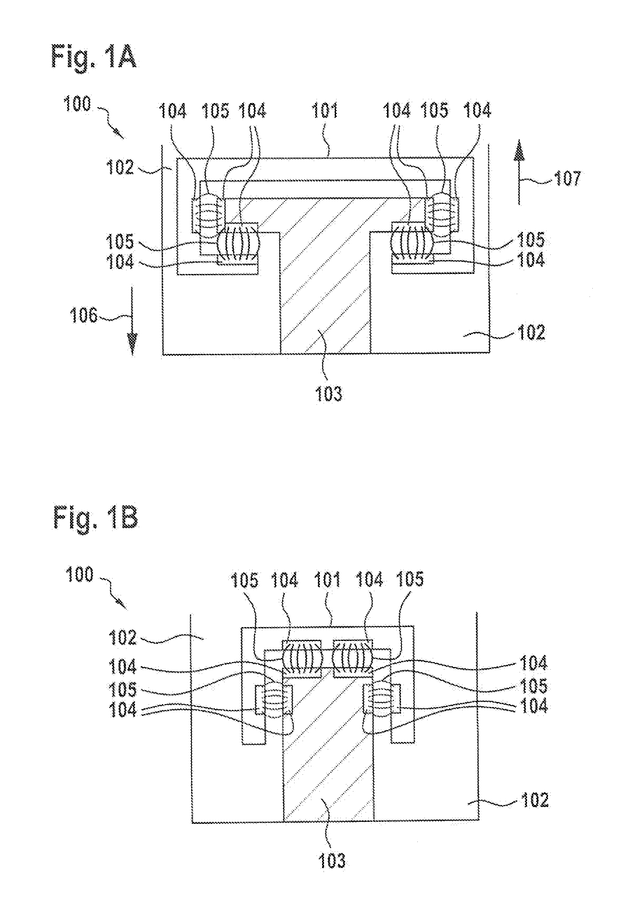

FIG. 1A shows by way of example the cross section of sampling unit 100. Sampling unit 100 includes a movable component 101. Movable component 101 is situated in magnetic channel 102, where it is movable along a T-shaped guide element 103. In the example, force of gravity 106 pulls movable component 101 downwardly onto guide element 103. However, guide element 103 is designed as a magnetic bearing due to magnets 104. Arrow 107 indicates the upwardly directed magnetic force due to the magnetic bearing. Thus, as a whole, this results in a magnetic force 105 that holds movable component 101 above guide element 103 in a quasi-floating manner. Magnetic force 105 is indicated by magnetic field lines in the drawings. In addition, as the result of magnetic force 105, there is no material contact between movable component 101 and guide element 103 at the sides. Movable component 101 is thus movable without material contact. The control of the magnetic bearing may take place with the aid of a bearing controller.

FIG. 1B shows by way of example a cross section of a sampling unit 100 having another design of guide element 103 and movable component 101. Sampling unit 100 includes the same elements as sampling unit 100 in FIG. 1A. The shapes of guide element 103 and of movable component 101 differ from the preceding example. For this reason, the position of magnets 104 within the sampling unit also differs. Also in this example, magnetic force 105 forms, as the result of which movable component 101 is movable above and along guide element 103 in a quasi-floating manner. The control of the magnetic bearing may take place with the aid of a bearing controller.

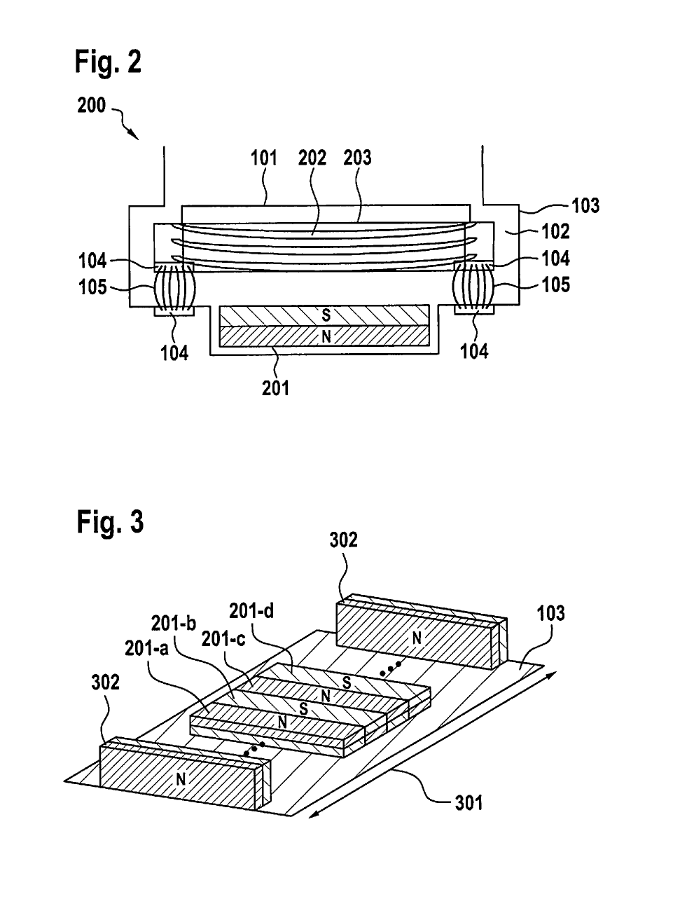

FIG. 2 shows by way of example the cross section of a sampling unit 200 according to another example embodiment. Guide element 103 and movable component 101 each has a different shape compared to the preceding examples. FIG. 2 also shows in particular the magnets of the linear drive. The linear drive is implemented as a linear motor. Guide element 103 includes magnets 201 for this purpose. Magnets 201 are designed as permanent magnets in the example.

Magnets 201 are positioned in the lower part of guide element 103, on the base. Movable component 101 includes magnets 202 for implementing the linear drive. Magnets 202 are designed as electromagnets in the example, and can include a magnetic core 203. The electromagnets are designed as coils. Magnets 202 are positioned in the base of component 101. Sampling unit 200 can thus be implemented with a flat design.

FIG. 3 schematically shows guide element 103 of sampling unit 200 from FIG. 2. Guide element 103 is illustrated in a simplified form here as a plane. This plane represents the area of guide element 103 on which magnets 201 are situated. In the example shown, guide element 103 has a linear design. The plane of the guide element is correspondingly illustrated with a rectangular shape. Guide element 103 can also have some other shape, for example a semicircular shape. In this case, the plane can likewise have a semicircular shape. For a semicircular guide element 103, magnets 201 can be shaped and/or arranged in such a way that they match the shape of guide element 103. The following discussions apply for any shape of guide element 103.

Magnets 201 are designed as permanent magnets in the example. A predefined number of magnets 201 are situated resting, in a manner of speaking, on the plane. Magnets 201 are situated in such a way that their respective north and south poles are situated one above the other along a perpendicular to the plane. The four magnets 201-a, 201-b, 201-c, and 201-d are illustrated here as an example. The north pole and the south pole of magnets 201-a, 201-b, 201-c, and 201-d in each case alternate with one another along movement direction 301. Due to the operating principle of the linear drive, in particular the linear motor, described above, movable component 101 (not shown for the sake of simplicity) can be moved along movement direction 301, along the guide element and within magnetic channel 102 of sampling unit 200. The position of movable component 101 on guide element 103 can be determined with the aid of the bearing controller of the magnetic bearing.

FIG. 3 also shows magnetic springs 302, which guide element 103 can include at its outer boundaries.

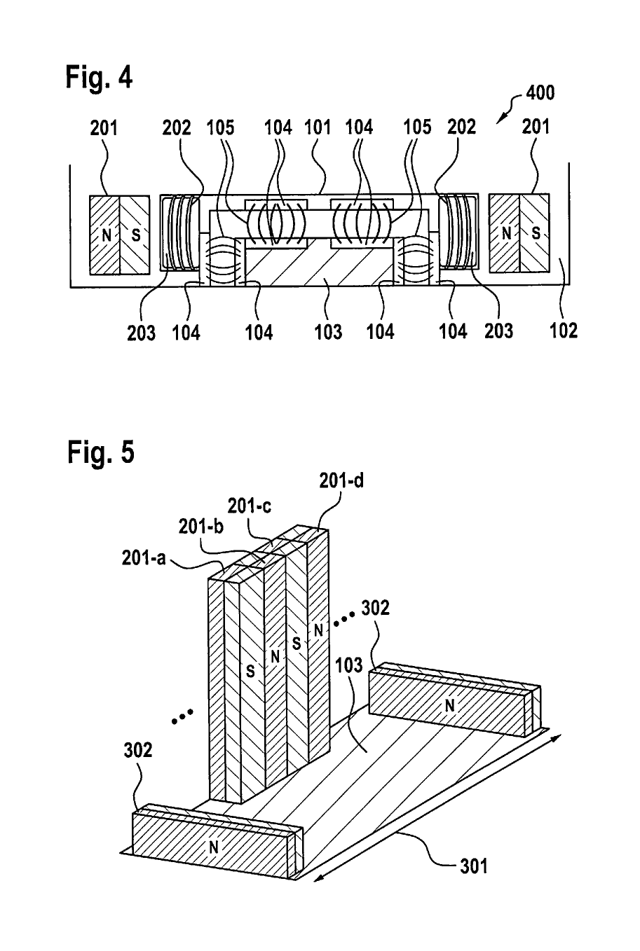

FIG. 4 shows by way of example the cross section of a further sampling unit 400 according to another example embodiment. Guide element 103 and movable component 101 each has a different shape compared to the preceding examples. FIG. 4 also shows the magnets of the linear drive. The linear drive is implemented as a linear motor. Guide element 103 includes magnets 201 for this purpose. Magnets 201 are designed as permanent magnets in the example. Magnets 201 are positioned on both sides of guide element 103. Movable component 101 includes magnets 202 for implementing the linear drive. Magnets 202 are designed as electromagnets in the example. The electromagnets are designed as coils. Magnets 202 are positioned on the sides of component 101. Sampling unit 200 can be very stable as a result.

FIG. 5 schematically shows guide element 103 of sampling unit 400 from FIG. 4. Guide element 103, the same as in FIG. 3, is illustrated in a simplified form as a plane. For the sake of simplicity, only magnets 201 on one side of guide element 103 are illustrated. In the example shown, guide element 103 has a linear design. The plane of guide element 103 is correspondingly illustrated with a rectangular shape. Guide element 103 can also have some other shape, for example a semicircular shape. In this case, the plane can likewise have a semicircular shape. For a semicircular guide element 103, magnets 201 can be shaped and/or arranged in such a way that they match the shape of guide element 103. The following discussions apply for any shape of guide element 103.

Magnets 201 are designed as permanent magnets. A predefined number of magnets 201 are situated resting, in a manner of speaking, on the plane. Magnets 201 are situated in such a way that their respective north and south poles are situated in parallel to the plane and one above the other and perpendicular to movement direction 301. The four magnets 201-a, 201-b, 201-c, and 201-d are illustrated here as an example. The north pole and the south pole of magnets 201-a, 201-b, 201-c, and 201-d alternate with each other along movement direction 301. Due to the operating principle of the linear drive, in particular the linear motor, described above, movable component 101 (not shown for the sake of simplicity) can be moved along movement direction 301, along guide element 103 and within magnetic channel 102 of sampling unit 200. The position of movable component 101 on guide element 103 can be determined with the aid of the bearing controller of the magnetic bearing.

FIG. 5 also shows magnetic springs 302, which guide element 103 can include at its outer boundaries.

The cross section of a sampling unit according to the present invention can correspond to the cross section shown in FIG. 1A, 1B, 2, or 4. Movable component 101 or guide element 103 can also have other shapes not shown here. Magnets 104, 201, or 202 may be positioned at other locations of the sampling unit not shown here. Other cross sections of a sampling unit, not shown here, can thus be provided.

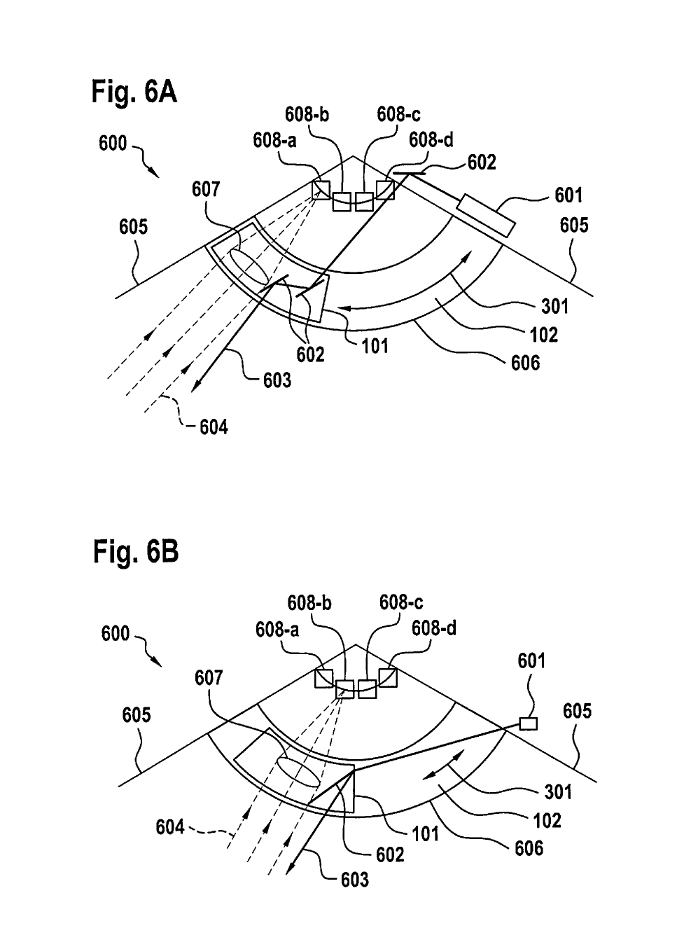

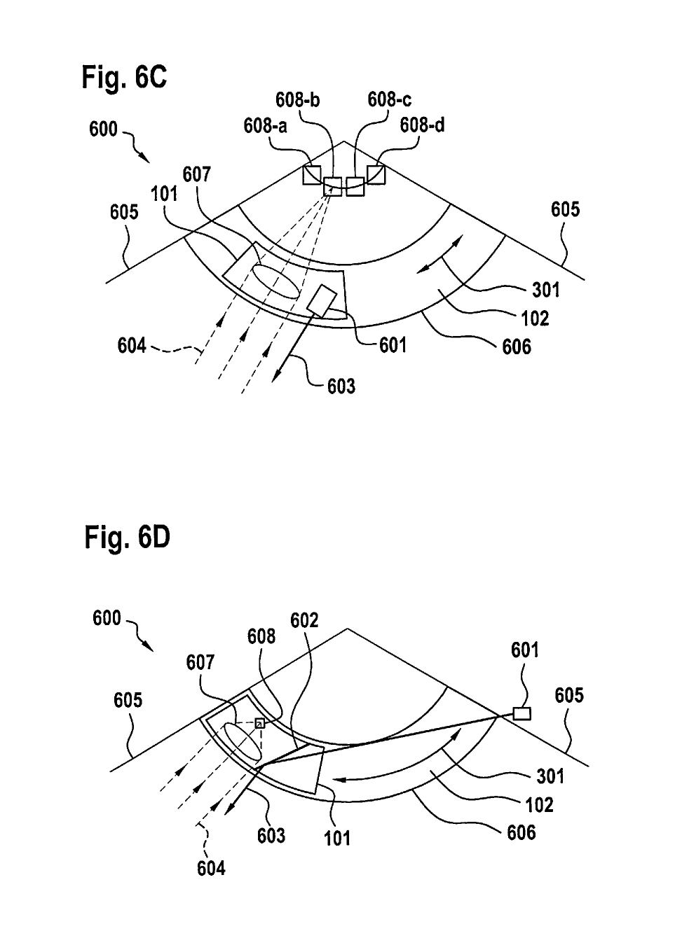

FIGS. 6A through 6D each shows a respective example embodiment of a LIDAR sensor 600. In each of the four examples, LIDAR sensor 600 includes a sampling unit 606. Magnetic channel 102 of sampling unit 606 has a semicircular shape. Movable component 101 can move within magnetic channel 102 along movement direction 301. At least refractive element 607 is situated on movable component 101. In each of the four examples, LIDAR sensor 600 includes a light source 601. Light source 601 can be designed as a laser. With the aid of light source 601, light 603 is emitted from LIDAR sensor 600 into the sampling space indicated by the two straight lines 605. The angle spanned by the two straight lines 605 indicates the visual field of the LIDAR sensor in this plane. Light 604 that has been reflected on an object in the sampling space is received by LIDAR sensor 600. Received light 604 is focused onto a detector element 608 with the aid of refractive element 607. Refractive element 607 in each case is situated closer to sampling space 605 than is detector element 608.

In the example in FIG. 6A, light source 601 is positioned at a predefined distance from sampling unit 606. LIDAR sensor 600 also includes the three reflective elements 602. Two of the three reflective elements 602 are positioned on movable component 101. Movable component 101 can be movable along movement direction 301 with oscillation. Light 603 that is emitted from light source 601 can thus be reflected from reflective elements 602 and emitted into virtually any spatial angle of the sampling space. Detector element 608 includes multiple individual detector elements in the example. Detector elements 608-a, 608-b, 608-c, and 608-d are shown by way of example. Received light 604 can be focused in each case onto one of detector elements 608-a, 608-b, 608-c, and 608-d, depending on the position of movable component 101 in magnetic channel 102.

In the example in FIG. 6B, light source 601 is positioned at a predefined distance from sampling unit 606. LIDAR sensor 600 also includes a reflective element 602. Reflective element 602 is positioned on movable component 101. Reflective element 602 can be a mirror. The mirror can have a planar design. Movable component 101 can be movable along movement direction 301 with oscillation. Light 603 that is emitted from light source 601 can thus be reflected from reflective element 602 and emitted into virtually any spatial angle of the sampling space. Detector element 608 includes multiple individual detector elements in the example. Detector elements 608-a, 608-b, 608-c, and 608-d are shown by way of example. Received light 604 can be focused in each case onto one of detector elements 608-a, 608-b, 608-c, and 608-d, depending on the position of movable component 101 in magnetic channel 102.

In the example in FIG. 6C, light source 601 is positioned on movable component 101. A reflective element 602 can be dispensed with in this example. Movable component 101 can be movable along movement direction 300 with oscillation, so that light 603 emitted from light source 601 can be emitted directly into virtually any spatial angle of the sampling space. Detector element 608 includes multiple individual detector elements in the example. Detector elements 608-a, 608-b, 608-c, and 608-d are shown by way of example. Received light 604 can be focused in each case onto one of detector elements 608-a, 608-b, 608-c, and 608-d, depending on the position of movable component 101 in magnetic channel 102.

In the example in FIG. 6D, light source 601 is positioned at a predefined distance from sampling unit 606. LIDAR sensor 600 also includes a reflective element 602. Reflective element 602 is positioned on movable component 101. Reflective element 602 can be a mirror. The mirror can have a planar design. Movable component 101 can be movable along movement direction 301 with oscillation. Light 603 that is emitted from light source 601 can thus be reflected from reflective element 602 and emitted into virtually any spatial angle of the sampling space. In the example, detector element 608 is also positioned on movable component 101. The position of detector element 608 can also be changed by the movement of movable component 101. It can thus be sufficient for LIDAR sensor 600 to include only one detector element 608.

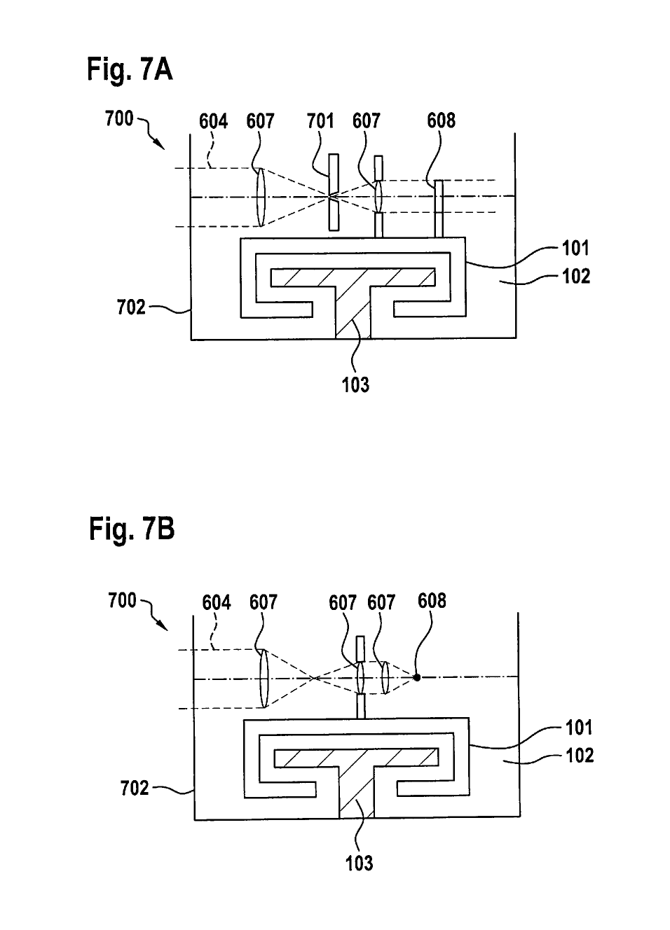

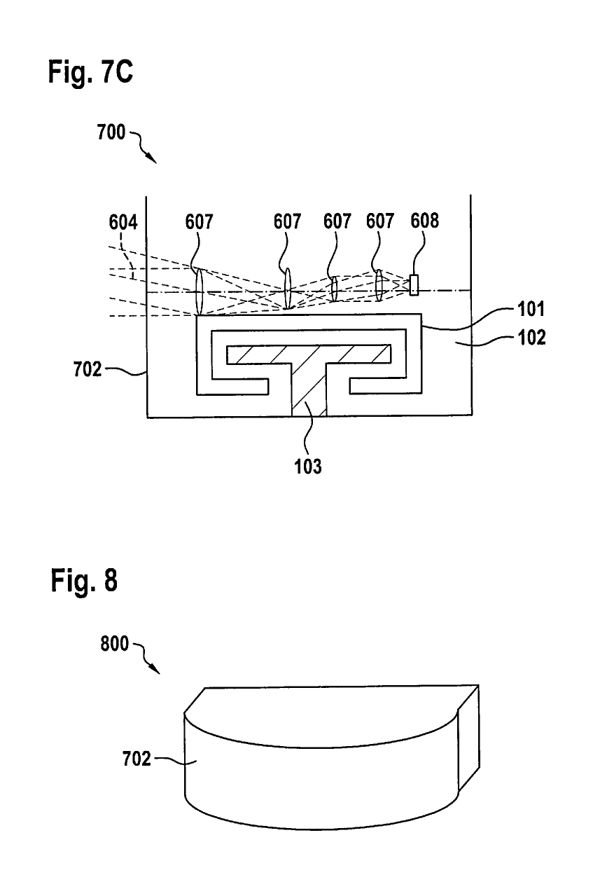

FIGS. 7A through 7C in each case show the cross section of a sampling unit 700 by way of example. Sampling unit 700 in each case includes a movable component 101. Movable component 101 is situated in magnetic channel 102. Movable component 101 is movable along a T-shaped guide element 103.

In FIG. 7A, refractive element 607 is situated on movable component 101. Refractive element 607 is formed from the two optical lenses 607. Received light 604 passes through front surface 702 of sampling unit 700. Received light 604 is focused onto an optical diaphragm 701 with the aid of first refractive element 607. Optical diaphragm 701 can advantageously block interfering radiation. The light is subsequently deflected onto detector element 608 with the aid of second refractive element 607. An additional angular enlargement can advantageously be achieved in this way.

In FIG. 7B, refractive element 607 is situated on movable component 101. Refractive element 607 is formed here from the three optical lenses 607. Received light 604 passes through front surface 702 of sampling unit 700. Received light 604 is focused with the aid of first refractive element 607. The light is subsequently deflected onto detector element 608 with the aid of second reflective element 607 and with the aid of third reflective element 607. In the example shown here, a small detector can be sufficient. An additional angular enlargement can advantageously be achieved in this way.

In FIG. 7C, refractive element 607 is situated on movable component 101. Refractive element 607 is formed here from the four optical lenses 607. Received light 604 passes through front surface 702 of sampling unit 700. Received light 604 is focused onto detector element 608 with the aid of the four optical lenses 607. An additional angular enlargement can advantageously be achieved in this way.

FIG. 8 shows the top view onto front surface 702 of a sampling unit 800 of a LIDAR sensor 600. The sampling unit can have one of the shown shapes. The sampling unit can also have other shapes that are not shown. In the example, front surface 702 includes an optical filter. In the example, the optical filter is designed as a coating on front surface 702.

What is claimed is:

1. A LIDAR sensor for detecting an object within a sampling space, the LIDAR sensor comprising:
a detector for receiving light that has been reflected from the object within the sampling space;
a sampling unit that includes:
a magnetic channel;
a guide; and
a movable component that is situated within the magnetic channel and is movable, under control of a linear drive, along the guide; and
a refractive element that is situated on the movable component and is situated closer to the sampling space than is the detector.

2. The LIDAR sensor of claim 1, wherein the guide is designed as a magnetic bearing.

3. The LIDAR sensor of claim 2, wherein the sampling unit also includes at least one permanent magnet.

4. The LIDAR sensor of claim 1, wherein the movable component is movable along the guide with oscillation.

5. The LIDAR sensor of claim 1, wherein the movable component is movable along the guide with resonant oscillation.

6. The LIDAR sensor of claim 1, wherein the guide includes magnetic springs at outer boundaries of the guide.

7. The LIDAR sensor of claim 1, wherein portions of the sampling unit are semicircular.

8. The LIDAR sensor of claim 1, wherein the magnetic channel and the guide are semicircular.

9. The LIDAR sensor of claim 1, wherein the refractive element includes at least one optical lens.

10. The LIDAR sensor of claim 1, further comprising:
a light source for emitting light into the sampling space.

11. The LIDAR sensor of claim 10, wherein the movable component includes at least one reflective optical element configured to deflect the light that is emitted from the light source into the sampling space.

12. The LIDAR sensor of claim 1, further comprising:
an optical filter situated on a side of the sampling unit facing the sampling space.

13. A method of a LIDAR sensor for detecting an object within a sampling space, the LIDAR sensor including a sampling unit, the method comprising:
controlling, with a linear drive, movement of a movable component of the sampling unit within a magnetic channel and along a guide; and
receiving light that has been reflected from the object within the sampling space.

14. The method of claim 13, wherein the guide is designed as a magnetic bearing, the method further comprising:
controlling the magnetic bearing with a bearing controller.

15. The method of claim 14, further comprising:
determining, with the bearing controller, a position of the movable component on the guide.

16. The method of claim 13, wherein the receiving of the light is performed by a detector and a refractive element that is situated on the movable component is situated closer to the sampling space than is the detector.
